(19) United States
(12) Patent Application Publication
(10) Pub. No.: US 2011/0035686 A1
(43) Pub. Date: Feb. 10, 2011

(54) SIMULATION OF A MEDIA RECORDING WITH ENTIRELY INDEPENDENT ARTISTIC AUTHORSHIP

(76) Inventor: Hank RISAN, Santa Cruz, CA (US)

Correspondence Address: MEDIA RIGHTS TECHNOLOGIES C/O WAGNER BLECHER LLP, 123 WESTRIDGE DRIVE, WATSONVILLE, CA, 95076, US

(21) Appl. No.: 12/537,137

(22) Filed: Aug. 6, 2009

(51) Int. Cl. G06F 3/048; G06Q 99/00; G06Q 50/00

(52) U.S. Cl. 715/757; 705/1.1

(57) ABSTRACT

A method and system for generating a simulation of a media recording with entirely independent artistic authorship is disclosed. One embodiment accesses a plurality of parameters from a media recording to generate a parametric field. In addition, a virtual 3-D environment including an original source point or pluralities of points of the media recording is generated. Then, at least one new and different capture point is selected by the operating artist from within the virtual 3-D environment. The operating artist then creates the performance desired by adjusting a plurality of parameters of the parametric field within the virtual 3-D environment based on the new and different source point staging and voicings to virtually record an entirely original independent audio and/or video work of authorship.

### FIELD

Embodiments of the present technology relates generally to the field of psychoacoustic and psychovisual simulation of a media recording.

### BACKGROUND

Previously, if a user wanted a particular song or movie, the user would have to go to a store and purchase a record, tape, CD, video or the like. However, digitized audio and video media has revolutionized the media distribution market. Presently, if a user wants to buy a particular song or video, the media can be purchased and downloaded from the Internet. For example, an end user can access any of a number of media distribution sites, purchase and download the desired media and then listen or watch the media repeatedly. However, if the downloaded media is copyright protected, copyright royalties are required to be paid each time a copy of the media is sold.

In general, if a copy of a copyrighted media recording is sold, the party selling the copy of the media is required to pay copyright royalties such as a performance royalty and a publishing royalty. Generally, the performance royalty is paid to the performers and producers of the media while the publishing royalty is paid to the artist who wrote the media. Presently, rules related to usage protection can be found under Title 17 of the United States Code as well as section 114 of the Copyright Act.

Moreover, for copyrighted media to be purchased at an online digital media store, sufficient rights must be obtained by the online store to provide a copy of the media for purchase and download. Then, upon purchase of the media, the online store is required to pay the copyright royalties for the copy of the media sold. For example, if the online store sells one copyrighted song to an end user for $1, the online store is currently required to pay approximately a $0.70 performance royalty and a few cents publishing royalty.

Accordingly, a media provider that provides a large database of media may provide large volumes of copyrighted media and may be required to pay large royalty fees.

### SUMMARY

A method and system for generating a simulation of a media recording with entirely independent artistic authorship is disclosed. One embodiment accesses a plurality of parameters from a media recording to generate a parametric field. In addition, a virtual 3-D environment including an original source point or pluralities of source points and an original capture point of the media recording is generated. Then, at least one new and different capture point is selected by the author from within the virtual 3-D environment. The operating artist then creates the performance desired by adjusting a plurality of parameters of the parametric field within the virtual 3-D environment based on the new and different source point staging and voicings in conjunction with the at least one new and different capture point to virtually record an entirely original independent audio and/or video work of authorship.

### BRIEF DESCRIPTION OF THE DRAWINGS

FIG. 1 is a block diagram of a media recording simulator with entirely independent artistic authorship in accordance with an embodiment of the present invention.

FIG. 2 is a block diagram of a simulation of a media recording with artistic authorship in a virtual environment in accordance with an embodiment of the present invention.

FIG. 3A is a block diagram of a simulation of a media recording with artistic authorship in a different virtual environment in accordance with an embodiment of the present invention.

FIG. 3B is a block diagram of a simulation of a media recording with artistic authorship in yet another different virtual environment in accordance with an embodiment of the present invention.

FIG. 4 is a flow chart of a method for simulation of a media recording with artistic authorship in accordance with an embodiment of the present invention.

FIG. 5 is a block diagram of a computer system in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview

According to 17 U.S.C. 106 and 114, an owner of copyright in a sound recording has exclusive rights to the sound recording. Copyright law also requires a plurality of copyright royalties paid to the copyright owner for the use of copyrighted work, such as but not limited to performance royalties and publishing royalties. The royalty rates are set by the Copyright Royalty Board. In order for a copyright owner to enforce and collect copyright royalties, the copyright owner must have a valid copyright that is registered with the United States Copyright Office.

However, the copyright owner in a sound recording is limited to the right to duplicate the sound recording in certain forms that directly or indirectly recapture the actual sounds fixed in the recording. Also, the copyright owner in a sound recording is limited to the right to prepare a derivative work in which the actual sounds fixed in the sound recording are rearranged, remixed, or otherwise altered in sequence or quality.

These exclusive rights of the owner of copyright in a sound recording do not extend to the making or duplication of another sound recording that consists entirely of an independent fixation of other sounds, even though such sounds imitate or simulate those in the copyrighted sound recording. In other words, copyright law allows one to create an imitation or simulation of a copyrighted sound recording as long as the imitated or simulated sounds are independently affixed; thus, the simulated work would be eligible to receive a copyright if sufficient artistic authorship is demonstrated.

### Operation

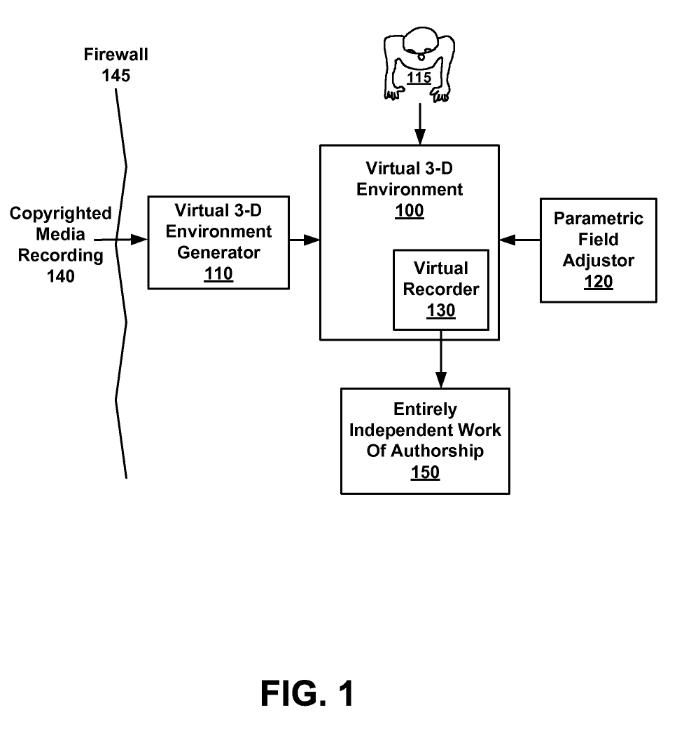

With reference now to FIG. 1, a media recording simulator with entirely independent artistic authorship is shown in accordance with one embodiment of the present technology. FIG. 1 includes a plurality of components such as copyrighted media recording 140, firewall 145, virtual 3-D environment generator 110, virtual 3-D environment 100, operating artist 115, parametric field adjustor 120, virtual recorder 130 and entirely independent work of authorship 150. Although a number of components are described in FIG. 1, they are shown according for clarity with respect to one embodiment of the present technology. However, the present technology is well suited to alternate embodiments that may include more, fewer or different components.

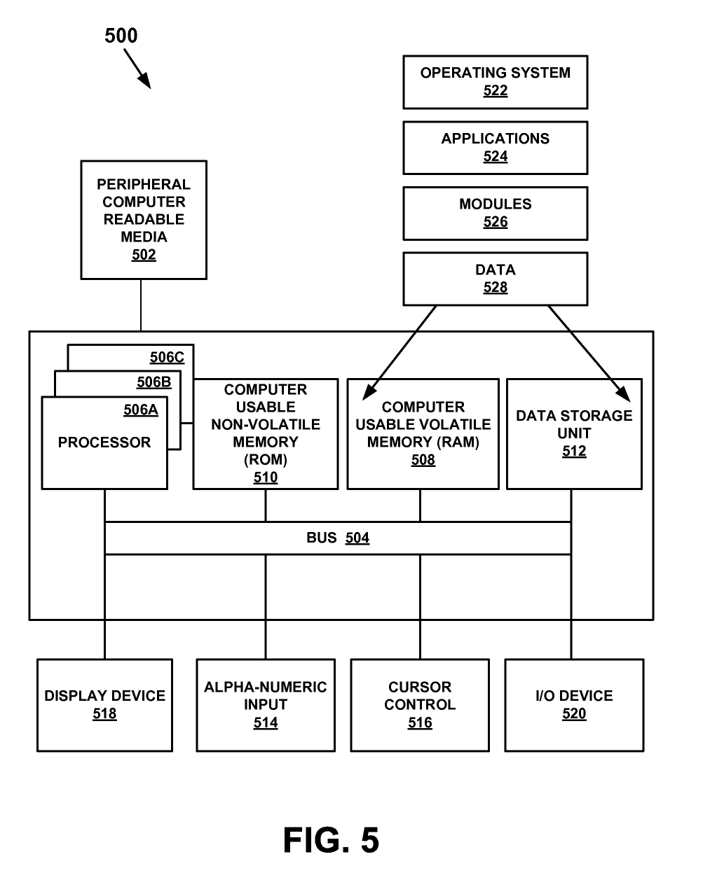

In general, one or more, or a portion of one or more, of the components of FIG. 1 may reside in a computer-readable and computer-executable instructions which reside, for example, in computer-usable media of a computer system, such as but not limited to the computer system 500 of FIG. 5.

In another embodiment, one or more, or a portion of one or more, of the components of FIG. 1 may be installed as software and/or hardware and utilized on any device that is capable of accessing music and/or media, such as a personal computer (PC), a laptop, a player/record, and a mobile device, among other things. Player/recorders may be digital, such as MP3 players. Examples of mobile devices include MP3 players, laptops, mobile phones, and portable computing devices, among other things.

In general, virtual 3-D environment generator 110 receives a copyrighted media recording 140. However, in one embodiment, prior to virtual 3-D environment generator 110 receiving the copyrighted media recording 140 sufficient rights to obtain copyrighted media recording 140. In one embodiment, the sufficient rights may be permission by the owner of the copyright of copyrighted media recording 140. In another embodiment, the sufficient rights are acquired by a mechanical license. A mechanical license allows for limited rights, such as, but not limited to, making a one-time copy for analytical study of the components of that copyrighted media recording 140. In one embodiment, the copy of copyrighted media recording 140 is in binary format such as in the form of a WAV file. However, copyrighted media recording 140 is also well suited to being MPEG, JPEG, MP3 or any other audio or visual media.

In one embodiment, virtual 3-D environment 100 in conjunction with operating artist 115 and parametric field adjustor 120 are utilized to generate an entirely independent work of authorship 150. In other words, as described in more detail herein, entirely independent work of authorship 150 is not a mix, recasting, digitization or imitation of copyrighted media recording 140 but is instead a new audio/visual performance, the independent work of operating artist 115, e.g., a performing artist and a producer. As such, entirely independent work of authorship 150 would be entitled to its own copyright protection and to copyright royalties because it is a wholly new work that is independently created.

In one embodiment, such as for security purposes, firewall 145 may be implemented prior to virtual 3-D environment generator 110 to ensure that the output of virtual 3-D environment 100 is an entirely independent work of authorship 150 that is wholly new and independent expression of operating artist 115 as opposed to a mere mechanical rendition or manipulation of the copyrighted media recording 140. In addition, firewall 145 can selectively allow for copying if the proper rights are granted by the copyright holder. In yet another embodiment, firewall 145 can be implemented prior to virtual 3-D environment 100.

Moreover, in another embodiment firewall 145 may be located in numerous different locations to ensure that the output of virtual 3-D environment 100 is an entirely independent work of authorship 150 that is wholly new and independent expression of operating artist 115 as opposed to a mere mechanical rendition or manipulation of the copyrighted media recording 140. Further, a plurality of firewalls 145 may be utilized. However, for purposes of clarity one of the pluralities of locations for firewall 145 is shown in FIG. 1.

With reference again to FIG. 1, in one embodiment, parametric field adjustor 120 utilizes psychoacoustics, that is, human production and mathematical modeling for the creation of entirely independent work of authorship 150. In one embodiment, any psychoacoustic or psychovisual modeling can be created by operating artist 115 and performed by parametric field adjustor 120 within virtual 3-D environment 100. Further detail is provided below.

Thus, virtual 3-D environment 100 outputs an entirely independent work of authorship 150. As described in more detail herein, entirely independent work of authorship 150 is entitled to their own copyright protection because they are new and different sounds that are distinct and artistically unique with respect to copyrighted media recording 140.

Moreover, entirely independent work of authorship 150 was not created by duplicating or directly or indirectly recapturing the sounds of copyrighted media recording 140. Entirely independent work of authorship 150 is not a derivative work in which the actual sounds fixed in copyrighted media recording 140 are rearranged, remixed or otherwise altered in sequence or quality. Instead, entirely independent work of authorship 150 is a simulation entirely based upon artistic decision making.

In one embodiment, virtual 3-D environment 100 distributes entirely independent work of authorship 150 to a requesting user.

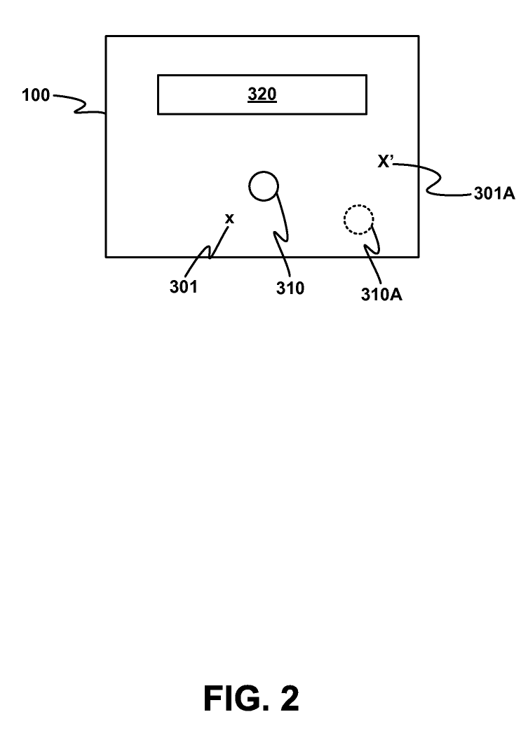

Referring now to FIG. 2, a block diagram of a psychoacoustic simulation of a media recording with entirely independent artistic authorship in a similar virtual environment is shown in accordance with an embodiment of the present invention. FIG. 2 includes virtual 3-D environment 100, original capture point 301, and original source points 310 and 320. In the present embodiment, original source point 310 is a vocalist while original source point 320 is a band.

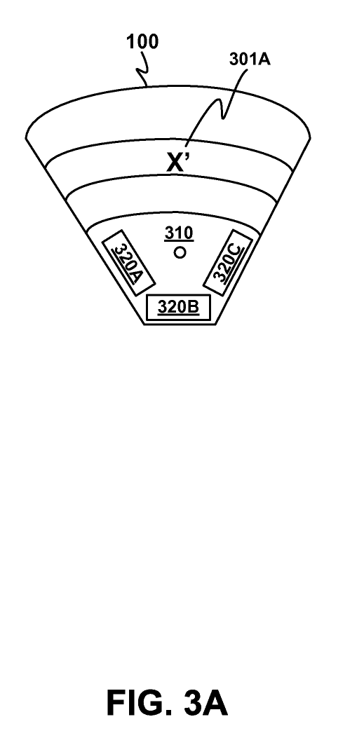

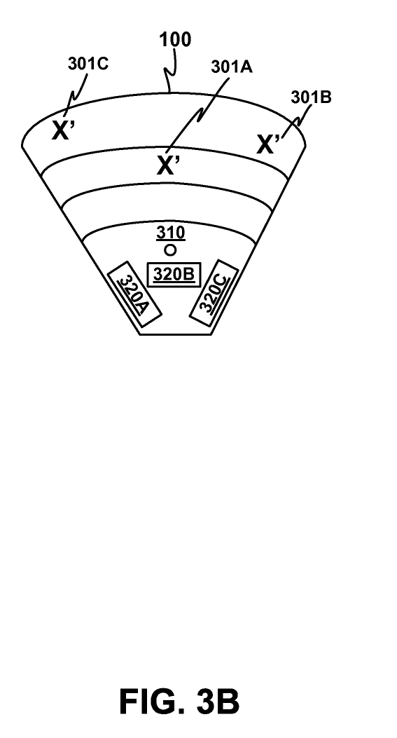

In addition, virtual 3-D environment 100 of FIG. 2 includes new and different capture point 301A, but could include multiple capture points as shown in FIG. 3B. In one embodiment, virtual 3-D environment 100 is a similar environment in which copyrighted media recording 140 was generated. For example, virtual 3-D environment 100 is a studio. Original capture point 301 is the location of the sound recording device, e.g., a microphone, which was utilized during the recording of copyrighted media recording 140. The source point location of vocalist 310 and band 320 are also virtual recreations suggested by operating artist 115 inputs. New and different capture point 301A is the location that was utilized by operating artist 115 within virtual 3-D environment 100 to generate entirely independent work of authorship 150.

In one embodiment, new and different capture point 301A is established by parametric field adjustor 120 adjusting a plurality of parameters of the parametric field within the virtual 3-D environment 100. In general, the pluralities of parameters that make up the parametric field are selected by operating artist 115 from the group including, but not limited to, pitch, loudness, duration of note, timbre and sound stage.

As described in detail herein, by adjusting a plurality of parameters of a parametric field within the virtual 3-D environment 100, artistic options such as changes in pitch, loudness, timbre and duration of note generate an entirely independent work of authorship 150. In addition, the establishment of a new and different capture point 301A allows virtual recorder 130 to generate an entirely independent work of authorship 150 that includes reshuffling of band 320 and/or vocalist 310 within virtual 3-D environment 100.

Although a vocalist 310 and band 320 are described in FIGS. 2, 3A and 3B, they are utilized merely for purposes of clarity within the examples. The technology is well suited to generating a virtual environment and entirely independent work of authorship 150 that are audio and/or video.

With reference to FIGS. 3A and 3B, block diagrams of a psychoacoustic simulation of a media recording with artistic authorship in different virtual 3-D environment 100 are shown. One major distinction with respect to both virtual 3-D environments of FIGS. 3A and 3B is the modification of the original location at which copyrighted media recording 140 was made. In other words, in the present example, copyrighted media recording 140 was generated in a closed recording studio. However, in FIGS. 3A and 3B, operating artist 115 in conjunction with parametric field adjustor 120, artistically adjusted a plurality of parameters of a parametric field within the virtual 3-D environments of FIGS. 3A and 3B. In other words, entirely independent work of authorship 150 simulates the generation of the recording in a concert hall, arena, ballpark, or other venue. In addition, as shown in virtual 3-D environment 100 of FIGS. 3A and 3B, original source point 320 has been separated into three new and different source points 320A, 320B and 320C. Further, three new and different source points 320A, 320B and 320C have been moved within the virtual 3-D environment 100 of FIG. 3A to generate entirely independent work of authorship 150.

In addition, virtual 3-D environment 100 of FIG. 3B shows additional artistic options including a number of possible locations for one or more new and different capture points, e.g., 301A, 301B and 301C. Moreover, virtual 3-D environment 100 of FIG. 3B shows another arrangement of three new and different source points 320A, 320B and 320C. Specifically, virtual 3-D environment 100 of FIG. 3B, shows new and different source point 320B having significantly more input into entirely independent work of authorship 150 than new and different source point 320B of virtual 3-D environment 100 of FIG. 3A.

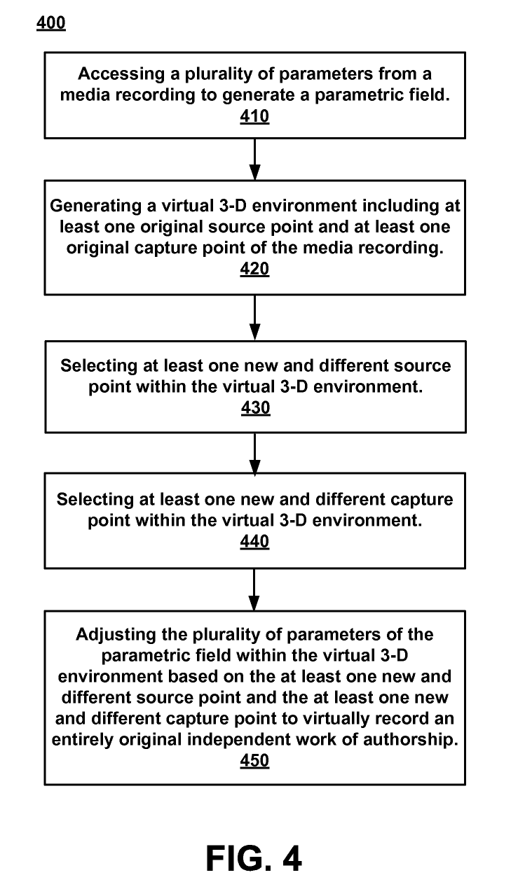

With reference now to FIG. 4 and also FIGS. 1 and 2, a flow chart of a method for psychoacoustic simulation of a media recording with entirely independent artistic authorship is shown in accordance with an embodiment of the present invention. Specifically, entirely independent work of authorship 150 is not a mix of a previously recorded song. Nor are effects added to an original recording to generate entirely independent work of authorship 150. Instead, the present technology generates a new and different entirely independent work of authorship 150. For example, the present technology provides a version of media that is fundamentally different based on the artist's new desire, artistic ear, and the like as parametric field adjustor 120 is operated to create a new product.

With reference now to 410 of FIG. 4, one embodiment accesses a plurality of parameters from the media recording to generate a parametric field. In one embodiment, the pluralities of parameters that make up the parametric field are selected from the group including, but not limited to, pitch, loudness, duration of note, timbre and sound stage.

In one embodiment, sound stage is the specific venue in which the recording of the work is made. The sound stage has a number of attributes, which include (but are not limited to) the following:

Whether the venue is enclosed or otherwise bounded

The shape of the venue

The acoustically reflective properties of the bounding materials for the venue

The location(s) of any wall(s), furniture, or other obstructions within the venue that can reflect sound.

For example, a bounded venue can be rectangular, consisting of four walls placed at right angles, with a floor and ceiling that is uniformly parallel to the floor. The venue could also have walls that are skewed, thus yielding a non-rectangular shape, or the ceiling might be vaulted or sloped. The venue could also have recessed storage areas. Each of these attributes would result in different acoustical characteristics. Concert halls and other performance venues will have similar attributes.

Referring now to 420 of FIG. 4 and to FIGS. 1 and 2, one embodiment generates a virtual 3-D environment 100 including an original capture point 301 of copyrighted media recording 140. In another embodiment, a plurality of original capture points 301 may be included within virtual 3-D environment 100.

With reference now to 430 of FIG. 4 and to FIGS. 2, 3A and 3B, one embodiment selects a new and different capture point 301A within virtual 3-D environment 100. In another embodiment, a plurality of new and different capture points 301A-301C may be selected within virtual 3-D environment 100.

With reference now to 440 of FIG. 4 and to FIG. 2, one embodiment selects a new and different source point 310A within virtual 3-D environment 100. In another embodiment, a plurality of new and different source points 320A-320C may be selected within virtual 3-D environment (as shown in FIGS. 3A and 3B).

Referring now to 450 of FIG. 4 and to FIGS. 1 and 2, one embodiment adjusts the plurality of parameters of the parametric field within virtual 3-D environment 100 based on the at least one new and different source point 310A and the at least one new and different capture point 301A to virtually record an entirely independent work of authorship 150.

For example, the methodology is similar to that of a number of different conductors leading the same orchestra. Each conductor will interpret and perform copyrighted media recording 140 in a different fashion. For example, one conductor may prefer more brass while another conductor may prefer more percussion. Yet another conductor may utilize cannon, while a fourth conductor may wish to emphasize a cowbell.

Therefore, although each conductor may have initially selected the same piece of music to conduct, each performance would be significantly different and recognizable based on the conductor's own artistic interpretations. In fact, it is quite reasonable to assume that over a period of time each conductor would place enough of his or her own artistic personality within their interpretations of the music such that upon hearing an orchestra play, a listener may be able to identify the conductor.

It is the same general principle of providing ones' own interpretation to the media (audio and/or video) that is utilized herein. That is, the resultant entirely independent work of authorship 150 is not a mix or a copy of previous work, but is instead a new interpretation and therefore a new work. For example, entirely independent work of authorship 150 may have emphasized the brass section and deemphasized the woodwind section, increased the pitch of the voice, decreased the level of the base, and the like. Moreover, it is well within the present technology to generate an entirely independent work of authorship 150 that has never previously been possible. For example, generating an entirely independent work of authorship 150 that utilizes the artist's interpretation of Frank Sinatra singing a song that was not published until after his death.

In other words, copyrighted media recording 140 is not copied, but is instead taken all the way back prior to the initial production and a new work created at the production level to produce a distinctly different version that is based on the interpretation and personality of operating artist 115 utilizing virtual 3-D environment 100 in conjunction with parametric field adjustor 120 to generate an entirely independent work of authorship 150.

For example, musical tones are produced by musical instruments or by the voice to create a sequence of pressurized spherical waves which propagate through air to the ears and convert into action potentials for the brain to process. Every musical sound in a sound recording has a point of origin called the source point. For example, in a recording of say a string quartet, there are 4 voices that are performing spatially in a 3-D sound stage. Based on a subjective analysis of the sound recording, an entirely new performance is generated by creating new voicings from specific source points in a 3-D sound stage determined by the producer.

In one embodiment, a producer performs an analysis on a copy of copyrighted media recording 140 from at least 5 parameters—pitch, loudness, duration of note, timbre and sound stage. The copy of copyrighted media recording 140 is then destroyed. Utilizing psychoacoustics, human authorship and advanced simulation topology, a new source point sound stage presentation with entirely new voices having different timbre, pitch, loudness and duration of note is created. The new and different capture point 301A is then utilized within the virtual 3-D environment 100 to generate a new performance based entirely on artistic subjective interpretation.

For example, in simulating Sinatra's voice a different timbre is used in a BlueBeat.com performance than what was originally created on the CD. The different timbre is a subjective interpretation of Sinatra's timbre based on knowledge of sound propagation of waves and the distortions of recording and digitization of operating artist 115. In other words, the new work is intended to capture the illusion of a live performance as might have been heard before the engineers started mechanically manipulating and the reproduction process started distorting Sinatra's actual voice. Thus, it is not actually Sinatra's voice that is being heard on BlueBeat.com. Instead, it is an artistic interpretation as to what he might have sounded like in the eyes of a new author. Moreover, it is not necessarily just the timbre of Sinatra's voice that may be subjectively interpreted. The artistic interpretation may also increase or reduce the influence of a particular instrument, a back-up vocal, or even add or remove sounds or instruments all together within the construct of an independently created sound stage.

As such, what is created is not a mix or copy of an original media recording. Instead, the result is a psychoacoustic illusion of a performance that in one embodiment may sound similar to a live musical performance instead of a studio track. In another embodiment, the result will be an entirely independent work created by the author that embodies a psychoacoustic illusion of a performance that reduced the influence of an over aggressive horn player or increased the influence of a back-up singer that was initially understated in the opinion of the producer without using the original sounds fixed in the underlying work. In so doing, what is created is a new entirely independent work of authorship 150.

Again, utilizing the previous conductor example, each conductor has their own understanding as to the strengths and weaknesses of a particular piece of music as well as the strengths and weaknesses of the performers performing the piece. As stated herein, a conductor's own personality will emanate through the music making it quite distinguishable from the work of another conductor. However, it is not only the conductor's personality that generates the new entirely independent work of authorship 150. There is also significant input and/or output from the actual performers being conducted as well as the location of the listener or recording device.

For example, in one performance, the conductor may notice that a particular musician or an entire section is performing at a higher level than normal. The conductor may recognize the higher level of performance and adjust his or her conducting with an entirely independent fixation of new sounds to better utilize the inspired performer or performers. Similarly, the conductor may recognize a performer having an off day and adjust his or her conducting to reduce the effect of the performer on the overall piece of work all done with new simulated sounds. This provides great latitude in artistic creation.

However, it is also quite possible that the conductor will not notice a performer having an inspired and/or off day until later in the performance or not at all. The present technology allows a different conductor the opportunity to return to the performance and single out the performer from the beginning. Thus, in one embodiment, the present technology will allow an operating artist 115 to emphasize a performer having a performance of a lifetime or deemphasize a performer having an off day.

For example, if a piece of media were recorded from a location, such as too close to the singer, with a faulty microphone or the like, operating artist 115 in conjunction with parametric field adjustor 120 operating within virtual 3-D environment 100 is capable of utilizing any or all of the media parameters, such as but not limited to pitch, loudness, duration of note, timbre and sound stage, to adjust the virtual ear location. For all intents and purposes, the subjective and artistic interpretation would be a reflection of the individual interpreting or conducting the entirely independent work of authorship 150. In other words, virtual 3-D environment 100 allows operating artist 115 to provide their own influence and personality to generate entirely independent work of authorship 150 in a fashion similar to that of a conductor, sound engineer or the like.

### Example Computer System Environment

With reference now to FIG. 5, portions of the technology for providing computer-readable and computer-executable instructions that reside, for example, in or on computer-usable media of a computer system. That is, FIG. 5 illustrates one example of a type of computer that can be used to implement one embodiment of the present technology.

Although computer system 500 of FIG. 5 is an example of one embodiment, the present technology is well suited for operation on or with a number of different computer systems including general purpose networked computer systems, embedded computer systems, routers, switches, server devices, user devices, various intermediate devices/artifacts, stand alone computer systems, mobile phones, personal data assistants, and the like.

In one embodiment, computer system 500 of FIG. 5 includes peripheral computer readable media 502 such as, for example, a floppy disk, a compact disc, and the like coupled thereto.

Computer system 500 of FIG. 5 also includes an address/data bus 504 for communicating information, and a processor 506A coupled to bus 504 for processing information and instructions. In one embodiment, computer system 500 includes a multi-processor environment in which a plurality of processors 506A, 506B, and 506C are present. Conversely, computer system 500 is also well suited to having a single processor such as, for example, processor 506A. Processors 506A, 506B, and 506C may be any of various types of microprocessors. Computer system 500 also includes data storage features such as a computer usable volatile memory 508, e.g. random access memory (RAM), coupled to bus 504 for storing information and instructions for processors 506A, 506B, and 506C.

Computer system 500 also includes computer usable non-volatile memory 510, e.g. read only memory (ROM), coupled to bus 504 for storing static information and instructions for processors 506A, 506B, and 506C. Also present in computer system 500 is a data storage unit 512 (e.g., a magnetic or optical disk and disk drive) coupled to bus 504 for storing information and instructions. Computer system 500 also includes an optional alpha-numeric input device 514 including alpha-numeric and function keys coupled to bus 504 for communicating information and command selections to processor 506A or processors 506A, 506B, and 506C. Computer system 500 also includes an optional cursor control device 516 coupled to bus 504 for communicating user input information and command selections to processor 506A or processors 506A, 506B, and 506C. In one embodiment, an optional display device 518 is coupled to bus 504 for displaying information.

Referring still to FIG. 5, optional display device 518 of FIG. 5 may be a liquid crystal device, cathode ray tube, plasma display device or other display device suitable for creating graphic images and alpha-numeric characters recognizable to a user. Optional cursor control device 516 allows the computer user to dynamically signal the movement of a visible symbol (cursor) on a display screen of display device 518. Implementations of cursor control device 516 include a trackball, mouse, touch pad, joystick or special keys on alpha-numeric input device 514 capable of signaling movement of a given direction or manner of displacement. Alternatively, in one embodiment, the cursor can be directed and/or activated via input from alpha-numeric input device 514 using special keys and key sequence commands or other means such as, for example, voice commands.

Computer system 500 also includes an I/O device 520 for coupling computer system 500 with external entities. In one embodiment, I/O device 520 is a modem for enabling wired or wireless communications between computer system 500 and an external network such as, but not limited to, the Internet.

Referring still to FIG. 5, various other components are depicted for computer system 500. Specifically, when present, an operating system 522, applications 524, modules 526, and data 528 are shown as typically residing in one or some combination of computer usable volatile memory 508, e.g. random access memory (RAM), and data storage unit 512. However, in an alternate embodiment, operating system 522 may be stored in another location such as on a network or on a flash drive. Further, operating system 522 may be accessed from a remote location via, for example, a coupling to the internet.

In one embodiment, the present technology is stored as an application 524 or module 526 in memory locations within RAM 508 and memory areas within data storage unit 512.

The present technology may be described in the general context of computer-executable instructions stored on computer readable medium that may be executed by a computer. However, one embodiment of the present technology may also utilize a distributed computing environment where tasks are performed remotely by devices linked through a communications network.

Although a number of embodiments have been described in terms of music, aspects described herein may be used for any form of media, such as music, movies, videos, DVDs, CDs, books, documents, graphics, etc.

Although “accessing” has been defined in terms of playing music, transmitting music, copying music, etc., “accessing” may also included displaying copyrighted media, for example, in the case of movies, DVDs, books, graphics, and documents.

It should be further understood that the examples and embodiments pertaining to the systems and methods for disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

What is claimed is:

1. A method for generating a simulation of a media recording with entirely independent artistic authorship, said method comprising:
accessing a plurality of parameters from a media recording to generate a parametric field;
generating a virtual 3-D environment including at least one original source point and at least one original capture point of said media recording;
selecting at least one new and different source point within said virtual 3-D environment;
selecting at least one new and different capture point within said virtual 3-D environment; and
adjusting said plurality of parameters of said parametric field within said virtual 3-D environment based on said at least one new and different source point and said at least one new and different capture point to virtually record an entirely original independent work of authorship.

2. The method of claim 1, further comprising:
utilizing a virtual recorder to record said entirely original independent work of authorship within said virtual 3-D environment.

3. The method of claim 1, wherein said plurality of parameters of said parametric field is selected from the group consisting of: pitch, loudness, duration of note, timbre and sound stage.

4. The method of claim 1, further comprising:
generating said virtual 3-D environment from the group of environments consisting of: sound booth, outdoor concert area, indoor concert area and stage.

5. The method of claim 1, further comprising:
utilizing a different environment for said virtual 3-D environment than an original environment in which said media recording occurred.

6. The method of claim 5, further comprising:
modifying said plurality of parameters of said parametric field within said 3-D environment based on assumed sound wave propagation characteristics.

7. The method of claim 1, further comprising:
modifying said plurality of parameters of said parametric field within said 3-D environment based on assumed sound wave recording and digitization distortion characteristics.

8. The method of claim 1, wherein said method further comprises:
utilizing an operating artist to perform said selecting of said at least one new and different source point within said virtual 3-D environment and said selecting said at least one new and different capture point within said virtual 3-D environment.

9. The method of claim 1, wherein said method further comprises:
obtaining a copyright registration on said entirely independent work of authorship.

10. A media recording simulator with entirely independent artistic authorship comprising:
a virtual 3-D environment generator for generating a virtual 3-D environment, said virtual 3-D environment including at least one original source point and at least one original capture point of a media recording;
an operating artist for selecting at least one new and different capture point within said virtual 3-D environment, said at least one new and different capture point distinct from said at least one original capture point;
a parametric field adjustor for adjusting a plurality of parameters of said parametric field within said virtual 3-D environment based on said at least one new and different capture point selected by said operating artist to generate an entirely independent work of authorship; and
a virtual recorder for recording said entirely original independent work of authorship within said virtual 3-D environment.

11. The media recording simulator with artistic authorship of claim 10 further comprising:
a plurality of new and different source points within said virtual 3-D environment, said plurality of new and different source points distinct from said original source points; and
said parametric field adjustor adjusting said plurality of parameters of said parametric field within said virtual 3-D environment based on said at least one new and different capture point in conjunction with said plurality of new and different source points to generate an entirely original independent work of authorship.

12. The media recording simulator with artistic authorship of claim 10 further comprising:
a virtual 3-D environment adjustor for modifying a size and shape of the virtual 3-D environment.

13. The media recording simulator with artistic authorship of claim 10 further comprising:
a psychoacoustic simulator configured to psychoacoustically analyze said copyrighted media recording.

14. A method for generating an entirely independent psychoacoustic simulation of a media recording with artistic authorship, said method comprising:
accessing a plurality of parameters from a media recording to generate a parametric field;
generating a virtual 3-D environment based on said parametric field, said virtual 3-D environment including an original capture point of said media recording;
adjusting said plurality of parameters of said parametric field within said virtual 3-D environment to generate at least one new and different source point within said virtual 3-D environment; and
recording an entirely independent work of authorship utilizing said at least one new and different source point within said virtual 3-D environment, said entirely independent work of authorship comprising a psychoacoustic simulation of a media recording with artistic authorship.

15. The method of claim 14, further comprising:
utilizing an operating artist to perform said selecting of said at least one new and different source point within said virtual 3-D environment and said selecting said at least one new and different capture point within said virtual 3-D environment.

16. The method of claim 14, wherein adjusting said plurality of parameters of said parametric field comprises:
adjusting pitch, loudness, duration of note, timbre and sound stage.

17. The method of claim 14, further comprising:
generating said virtual 3-D environment from the group of environments consisting of
sound booth, outdoor concert area, indoor concert area and stage.

18. The method of claim 14, further comprising:
utilizing a different environment for said virtual 3-D environment than an original environment of said media recording; and
modifying said plurality of parameters of said parametric field within said 3-D environment based on assumed sound wave propagation characteristics.

19. The method of claim 14, further comprising:
modifying said plurality of parameters of said parametric field within said 3-D environment based on assumed sound wave recording and digitization distortion characteristics.

20. The method of claim 14, wherein said method further comprises:
obtaining a copyright registration on said entirely independent work of authorship.
